(19) United States
(12) Patent Application Publication
(10) Pub. No.: US 2008/0030061 A1
(43) Pub. Date: Feb. 7, 2008

(54) MULTI-POSITION ADJUSTMENT MECHANISM

(76) Inventor: Srinivas Pejathaya, St. Clair Shores, MI (US)

Correspondence Address: HARNESS, DICKEY & PIERCE, P.L.C., P.O. BOX 828, BLOOMFIELD HILLS, MI, 48303, US

(21) Appl. No.: 11/833,407

(22) Filed: Aug. 3, 2007

Related U.S. Application Data
(60) Provisional application No. 60/835,917, filed on Aug. 4, 2006.

(51) Int. Cl. B60N 2/02

(52) U.S. Cl. 297/367; 297/463.1

(57) ABSTRACT

An adjustment mechanism includes a housing, a pawl rotatably supported by the housing, and a sector plate rotatably supported by the housing. The sector plate ratchets along the pawl in a first rotational direction and selectively locks the sector plate in one of a plurality of angular positions to prevent rotation of the sector plate in a second rotational direction relative to the housing. A reset lever is in selective engagement with the pawl to rotate the pawl out of engagement with the sector plate and permit rotation of the sector plate in the second rotational direction.

### CROSS-REFERENCE TO RELATED APPLICATIONS

This application claims the benefit of U.S. Provisional Application No. 60/835,917, filed on Aug. 4, 2006. The disclosure of the above application is incorporated herein by reference.

### FIELD

The present teachings relate to adjustment mechanisms, and more particularly, to an improved adjustment mechanism for use with a vehicle interior system.

### BACKGROUND

The statements in this section merely provide background information related to the present disclosure and may not constitute prior art.

Reconfigurable interior systems are becoming increasingly popular not only for use in minivans and sport utilities but also in sedans and compact cars to increase the overall capability and functionality of the particular vehicle. For example, many interior systems include a reconfigurable seating system that allows an occupant to position a seat assembly in one of a use position, a fold-flat position, and a dumped position. Such seat assemblies provide the ability to tailor an interior of a vehicle to suit the particular needs of the occupant.

Interior systems may also include various features designed to optimize the overall comfort of a vehicle by providing amenities that allow an occupant to manipulate and adjust the configuration of the interior system. For example, a seat assembly may include a recliner mechanism that permits an occupant to adjust an angular position of a seatback relative to a seat bottom, an adjustment mechanism that allows the occupant to position the seat assembly in a desired fore-aft position relative to the vehicle, a headrest assembly for receiving and supporting a head of an occupant, and an armrest assembly for receiving and supporting an arm of an occupant.

Conventional headrest assemblies typically provide for limited adjustment of a headrest relative to a seatback of a seat assembly. Similarly, conventional armrest assemblies typically provide for limited adjustment of an armrest relative to a seatback of a seat assembly and limit such adjustment to positioning the armrest in one of the use position and the stowed position.

While conventional headrest assemblies and armrest assemblies provide for slight adjustment relative to a seat assembly, such conventional headrest assemblies and armrest assemblies do not allow for rotatably positioning a headrest or an armrest in one of a plurality of angular positions relative to a seat assembly. Furthermore, conventional headrest assemblies and armrest assemblies do not provide an occupant with the choice of either returning the headrest or armrest to a use position or continuing rotation of the headrest or armrest into a stowed position once the headrest or armrest has been moved through each possible angular position.

### SUMMARY

An adjustment mechanism includes a housing, a pawl rotatably supported by the housing, and a sector plate rotatably supported by the housing. The sector plate ratchets along the pawl in a first rotational direction and selectively locks the sector plate in one of a plurality of angular positions to prevent rotation of the sector plate in a second rotational direction relative to the housing. A reset lever is in selective engagement with the pawl to rotate the pawl out of engagement with the sector plate and permit rotation of the sector plate in the second rotational direction.

An adjustment mechanism includes a housing, a sector plate rotatably supported by the housing, and a pawl rotatably supported by the housing and in selective engagement with the sector plate to position the sector plate in one of a use position, an intermediate position, and a stowed position. The sector plate is rotatable from the intermediate position in a first direction into the stowed position and is rotatable in a second direction from the intermediate position into the use position.

A seat assembly includes a seat bottom, a seatback rotatably supported by the seat bottom, at least one of an armrest assembly and a headrest assembly movable relative to the seatback, and an adjustment mechanism associated with the at least one armrest assembly and headrest assembly. The adjustment mechanism includes a housing fixed for rotation with one of the seat bottom and the seatback, a sector plate rotatably supported by the housing and rotatable with at least a portion of the at least one armrest assembly and headrest assembly, and a pawl rotatably supported by the housing and in selective engagement with the sector plate to position the sector plate in one of a use position, an intermediate position, and a stowed position relative to the seatback. The sector plate is rotatable from the intermediate position in a first direction into the stowed position and is rotatable in a second direction from the intermediate position into said use position.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a seat assembly incorporating an armrest and a headrest in accordance with the principles of the present teachings;

FIG. 2 is a side view of an armrest assembly in a use position with part of a housing removed to show internal components of an adjustment mechanism associated with the armrest assembly;

FIG. 3 is a side view of the adjustment mechanism of FIG. 2 in an adjusted position;

FIG. 4 is an enlarged view of the adjustment mechanism of FIG. 2 in a transition position;

FIG. 5 is a side view of the adjustment mechanism of FIG. 2 moving from a transition position to a use position;

FIG. 6 is a side view of the adjustment mechanism of FIG. 2 moving from a transition position toward a stowed position;

FIG. 7 is a side view of the adjustment mechanism of FIG. 2 in a stowed position;

FIG. 8 is a side view of a headrest assembly in a use position with part of a housing removed to show internal components of an adjustment mechanism associated with the headrest assembly;

FIG. 9 is a side view of the adjustment mechanism of FIG. 8 moving from a transition position toward a stowed position; and

FIG. 10 is a side view of the adjustment mechanism of FIG. 8 in the stowed position.

### DETAILED DESCRIPTION

The following description is merely exemplary in nature and is not intended to limit the present disclosure, application, or uses.

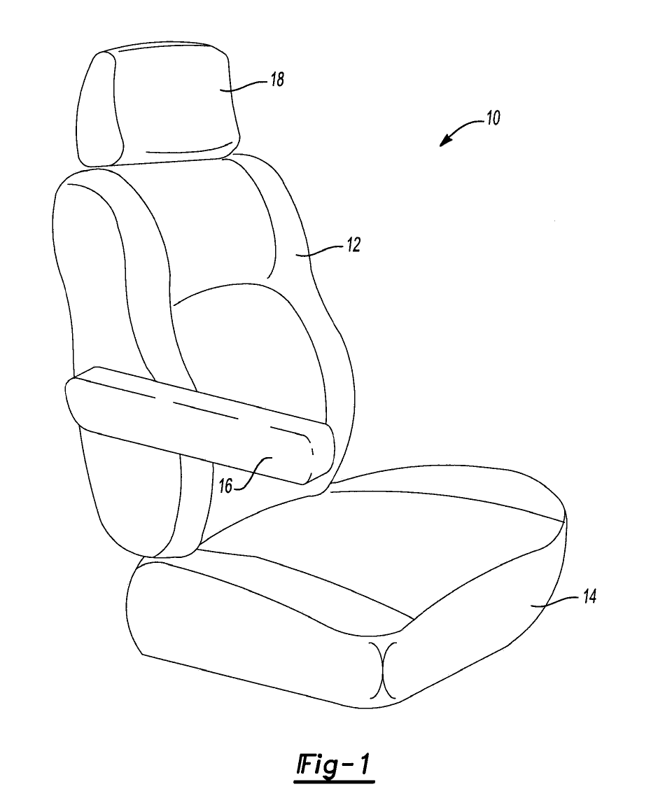

With reference to FIG. 1, a seat assembly 10 is provided and includes a seatback 12, a seat bottom 14, an armrest assembly 16, and a headrest assembly 18. One or both of the armrest assembly 16 and headrest assembly 18 may include an adjustment mechanism that provides for adjustment of the armrest assembly 16 and/or headrest assembly 18 relative to at least one of the seatback 12 and seat bottom 14.

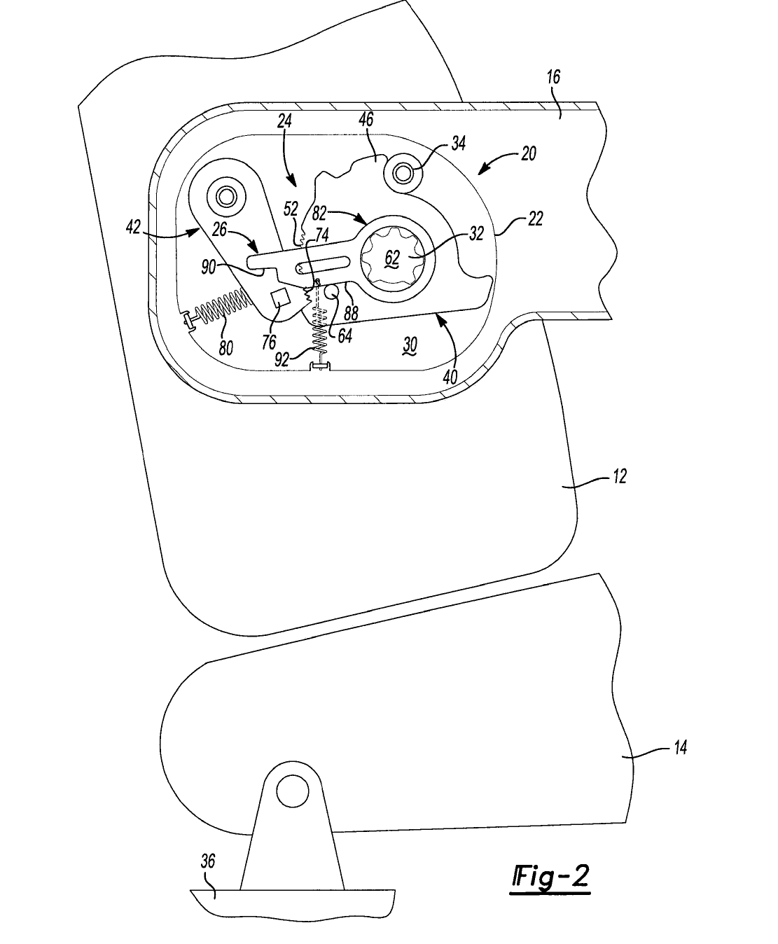

Referring now to FIG. 2, the adjustment mechanism 20 may include a housing 22, a locking mechanism 24, and a release mechanism 26. The locking mechanism 24 and release mechanism 26 cooperate to selectively permit rotation of the armrest assembly 16 and/or the headrest assembly 18 relative to the housing 22 and also cooperate to selectively lock the armrest assembly 16 and/or the headrest assembly 18 relative to the housing 22 in one of a plurality of angular positions as well as in a stowed position. While the adjustment mechanism 20 may be used with either the armrest assembly 16 or the headrest assembly 18, the components and operation of the adjustment mechanism 20 will be described hereinafter as being associated with the armrest assembly 16.

The housing 22 of the adjustment mechanism 20 rotatably supports the locking mechanism 24 and the release mechanism 26 and includes a generally planar surface 30, an aperture 32, and a post 34 attached thereto. The housing 22 may be fixedly attached to the seatback 12 or to the seat bottom 14 such that rotation of the armrest assembly 16 relative to the housing 22 causes the armrest assembly 16 to similarly be rotated relative to the seatback 12 and seat bottom 14. While the housing 22 is described as being attached to one of the seatback 12 and the seat bottom 14, the housing 22 could alternatively be attached to an external structure such as, but not limited to, a vehicle floor (schematically represented by reference numeral 36 in FIG. 2).

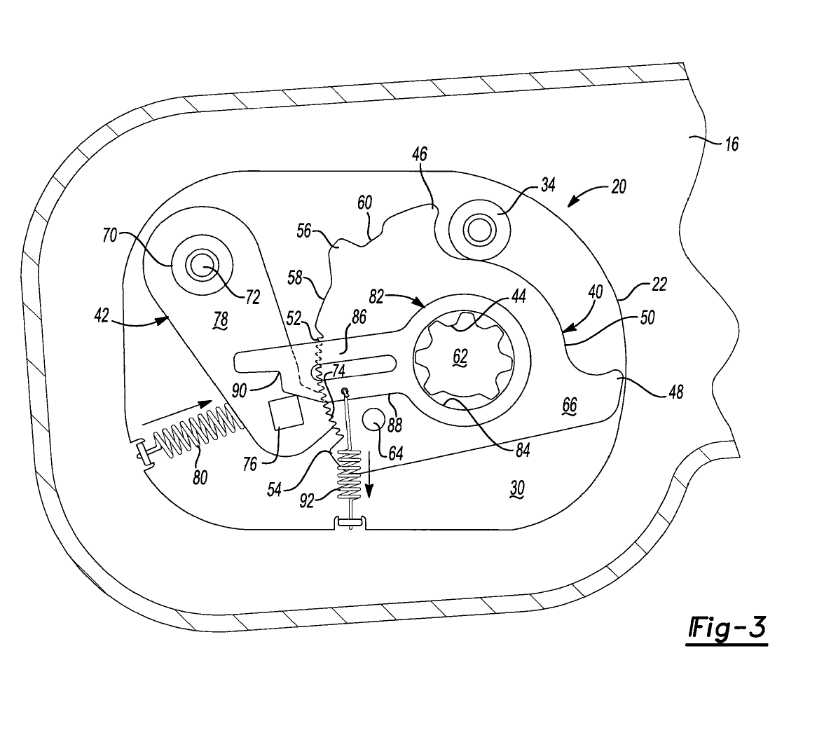

With reference to FIG. 3, the locking mechanism 24 is supported by the housing 22 and includes a sector plate 40 and a pawl 42. The sector plate 40 includes a central keyed aperture 44, a horizontal stop 46, a stow stop 48, and an arcuate surface 50 extending generally between the horizontal stop 46 and the stow stop 48. The sector plate 40 also includes a plurality of teeth 52, a shoulder 54, a projection 56 and a raised, arcuate surface 58. The plurality of teeth 52 extend between the shoulder 54 and the arcuate surface 58. The arcuate surface 58 extends generally from the plurality of teeth 52 to a base of the projection 56. A detent 60 is defined between the projection 56 and the horizontal stop 46 and selectively receives the pawl 42 to lock the armrest assembly 16 in the stowed position.

The central keyed aperture 44 may be matingly received by a rod 62 of the armrest assembly 16 or the seatback 12 to fix the sector plate 40 for rotation with the armrest assembly 16. The horizontal stop 46 and stow stop 48 are in selective engagement with the post 34 of the housing 22 and generally define an overall range of angular motion of the armrest assembly 16 relative to the housing 22. The arcuate surface 50 extending between the horizontal stop 46 and the stow stop 48 provides a path on which the post 34 may ride. Alternatively, the arcuate surface 50 may be spaced apart from the post 34 to allow clearance between the sector plate 40 and the post 34 during movement of the sector plate 40 relative to the housing 22.

The plurality of teeth 52 of the sector plate 40 cooperate with the pawl 42 to selectively lock the armrest assembly 16 in one of a plurality of angular positions relative to the housing 22. In one exemplary embodiment, the plurality of teeth 52 may include a predetermined number of teeth to allow the armrest assembly 16 to be positioned at an angle substantially between zero to 30 degrees relative to the housing 22.

The detent 60 is disposed on an opposite side of the projection 56 from the arcuate surface 58 and is defined generally by the projection 56 and the horizontal stop 46. The detent 60 selectively engages the pawl 42 to position and retain the armrest assembly 16 in the stowed position. A release post 64 is fixed for movement with the sector plate 40 and extends generally from a surface 66 of the sector plate 40 for selective engagement with the release mechanism 26, as will be described further below.

The pawl 42 includes a central pivot aperture 70 that receives a pivot 72 for rotatably supporting the pawl 42 relative to the housing 22. The pawl 42 also includes a plurality of teeth 74 and a post 76 that extends generally from a surface 78 of the pawl 42. A biasing member 80 engages the pawl 42 to bias the pawl 42 in a counterclockwise direction relative to the view shown in FIG. 3. The biasing member 80, while shown as a linear spring, may be any suitable device that rotationally biases the pawl 42 in the counterclockwise direction relative to the view shown in FIG. 3 such as, but not limited to, a coil spring or a leaf spring.

The release mechanism 26 includes a reset lever 82 that selectively engages the post 76 of the pawl 42. When in engagement with the post 76, the reset lever 82 prevents the plurality of teeth 74 of the pawl 42 from engaging the plurality of teeth 52 of the sector plate 40 to permit rotation of the sector plate 40 relative to the housing 22. The reset lever 82 includes a central aperture 84 that permits the reset lever 82 to be rotationally supported relative to the housing 22. In one configuration, the central aperture 84 of the reset lever 82 may be rotationally supported by the rod 62 of the armrest assembly 16 or the seatback 12.

The reset lever 82 also includes a lever extension 86 extending generally from the central aperture 84, an engagement surface 88 for selective engagement with the post 64 of the sector plate 40, and a recess 90 for selective engagement with the post 76 of the pawl 42. A biasing member 92 rotationally biases the reset lever 82 in the counterclockwise direction relative to the view shown in FIG. 3. While the biasing member 92 is shown as a linear spring, the biasing member 92 may be any suitable device that rotationally biases the reset lever 82 in the counterclockwise direction relative to the view shown in FIG. 3 such as, but not limited to, a coil spring or a leaf spring.

With continued reference to FIGS. 2-7, operation of the adjustment mechanism 20 will be described in detail. When the teeth 74 of the pawl 42 are engaged with the teeth 52 of the sector plate 40 such that a distal end of the pawl 42 is disposed in close proximity to the shoulder 54 of the sector plate 40, the armrest assembly 16 is in a use position and is substantially parallel to ground (FIG. 2). In this position, the sector plate 40 and, thus, the armrest assembly 16, are prevented from rotating in the clockwise direction relative to the housing 22 due to engagement between the teeth 74 of the pawl 42 and the teeth 52 of the sector plate 40 as well as due to engagement between the post 34 and the horizontal stop 46.

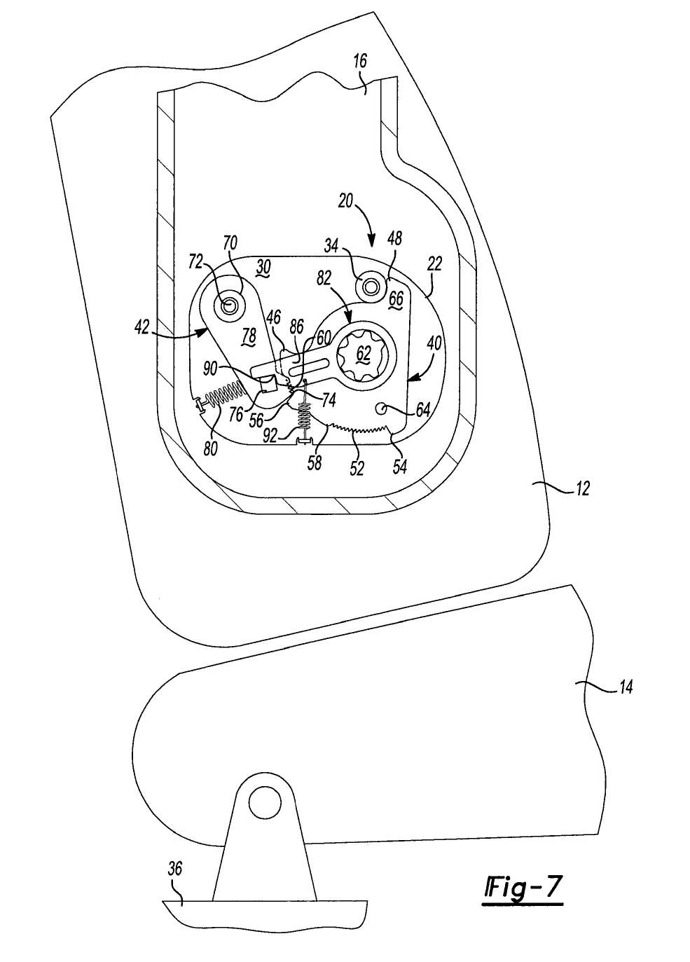

Any number of teeth 52 may be provided on the sector plate 40 to allow the armrest assembly 16 to be positioned in a plurality of angular positions relative to the housing 22. In one configuration, the number of teeth 52 provided on the sector plate 40 allows the sector plate 40 and, thus, the armrest assembly 16, to be positioned in a plurality of angular positions ranging from the use position (i.e., zero degrees) up to a substantially thirty-degree angle relative to the housing 22. As described, the armrest assembly 16 may be positioned in the use position anywhere from zero to thirty degrees relative to the housing 22 (FIG. 3) or to the stowed position of ninety degrees (FIG. 7).

To rotate the armrest assembly 16 and, thus, the sector plate 40 relative to the housing 22 from the use position to an adjusted position (i.e., an angled position), a force may be applied to the armrest assembly 16 to cause the armrest assembly 16 and the sector plate 40 to rotate relative to the housing 22 in the counterclockwise direction relative to the view shown in FIG. 3. Rotation of the sector plate 40 relative to the housing 22 in the counterclockwise direction causes the teeth 52 of the sector plate 40 to ratchet along the teeth 74 of the pawl 42 due to the sloped nature of the teeth 52, 74.

During ratcheting of the sector plate 40 along the pawl 42, the armrest assembly 16 is rotated relative to the housing 22 to position the armrest assembly 16 in a desired angular position relative to the housing 22. Once the desired angular position is achieved, the force applied to the armrest assembly 16 may be released to allow the teeth 74 of the pawl 42 to engage the teeth 52 of the sector plate 40 to prevent the sector plate 40 and, thus, the armrest assembly 16, from rotating in the clockwise direction relative to the view shown in FIG. 3. Because of the angle of the teeth 52, 74, the teeth 74 of the pawl 42 engage the teeth 52 of the sector plate 40 to prevent rotation of the sector plate 40 in the clockwise direction relative to the view shown in FIG. 3.

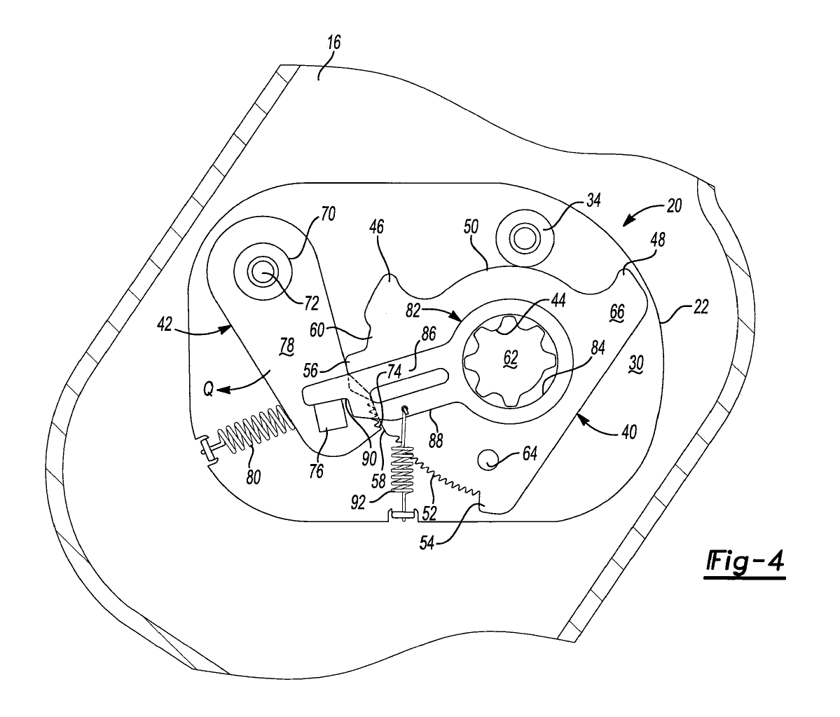

If the sector plate 40 is sufficiently rotated in the counterclockwise direction such that the pawl 42 disengages the teeth 52 of the sector plate 40, the teeth 74 of the pawl 42 engage the arcuate surface 58, as shown in FIG. 4. Because the arcuate surface 58 extends from the sector plate 40 a greater distance than the teeth 52 of the sector plate 40, the sector plate 40 exerts a force on the pawl 42 and causes the pawl 42 to rotate against the bias of biasing member 80 and in the clockwise direction relative to the view shown in FIG. 4, as shown by arrow Q in FIG. 4.

Rotation of the pawl 42 in the clockwise direction relative to the view shown in FIG. 4 causes the post 76 of the pawl 42 to engage the reset lever 82 and is eventually received within the recess 90 of the reset lever 82 once the sector plate 40 has been sufficiently rotated relative to the housing 22 from an angled position. Engagement between the post 76 of the pawl 42 and the recess 90 of the reset lever 82 prevents the biasing member 80 from urging the teeth 74 of the pawl 42 into engagement with the teeth 52 of the sector plate 40 due to the length of the lever extension 86. By maintaining the teeth 74 of the pawl 42 spaced apart from the teeth 52 of the sector plate 40, the sector plate 40 is permitted to rotate in the clockwise direction relative to the pawl 42 and the housing 22.

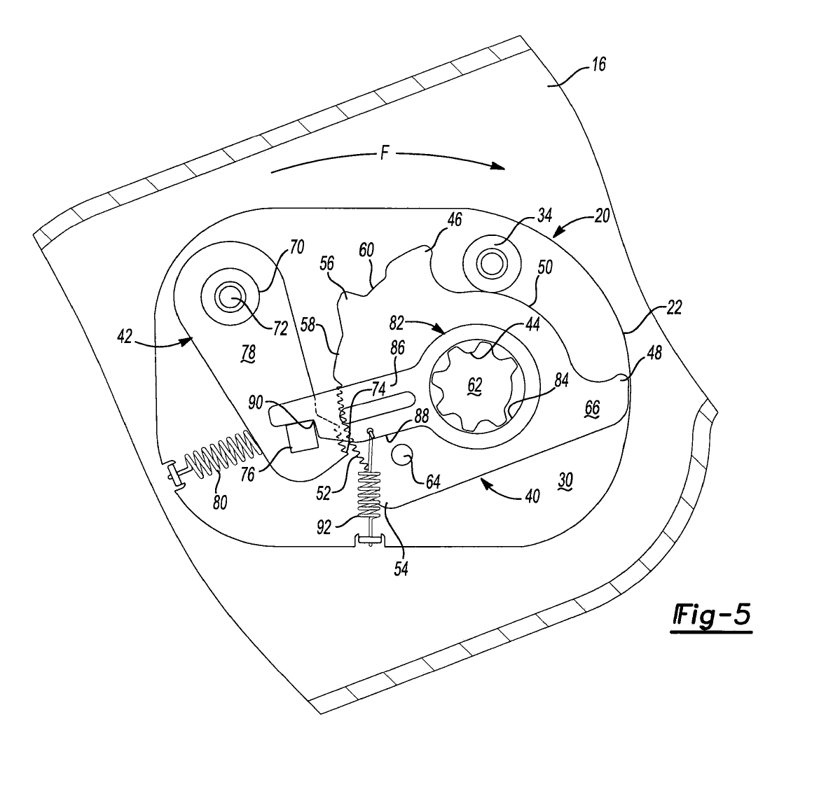

Once the armrest assembly 16 and the sector plate 40 have been sufficiently rotated in the counterclockwise direction relative to the view shown in FIG. 5 such that the teeth 74 of the pawl 42 are not aligned with the teeth 52 of the sector plate 40, but rather, are aligned with the arcuate surface 58 of the sector plate 40, the armrest assembly 16 may be moved into one of two positions; either returned to the use/angled use position (FIG. 5) or to the stowed position (FIG. 7).

To position the armrest assembly 16 back into the use position, a force F is applied to the armrest assembly 16 in the clockwise direction relative to the view shown in FIG. 5. Rotation of the armrest assembly 16 in the clockwise direction relative to the view shown in FIG. 5 is permitted as the teeth 74 of the pawl 42 are prevented from engaging the teeth 52 of the sector plate 40 due to engagement between the post 76 of the pawl 42 and the recess 90 of the reset lever 82. Once the armrest assembly 16 and the sector plate 40 have been sufficiently rotated in the clockwise direction relative to the view shown in FIG. 11, the post 76 of the sector plate 40 contacts the engagement surface 88 of the reset lever 82 preventing further rotation of the reset lever 82 in the counterclockwise direction relative to the view shown in FIG. 5.

Preventing further rotation of the reset lever 82 in the counterclockwise direction relative to the view shown in FIG. 5 allows the post 76 of the pawl 42 to disengage the recess 90 of the reset lever 82 and, therefore, allows the teeth 74 of the pawl 42 to once again engage the teeth 52 of the sector plate 40 under force from the biasing member 80 such that the distal end of the pawl 42 is adjacent to the shoulder 54 of the sector plate 40 and the armrest assembly 16 and the sector plate 40 are once again locked in the use position.

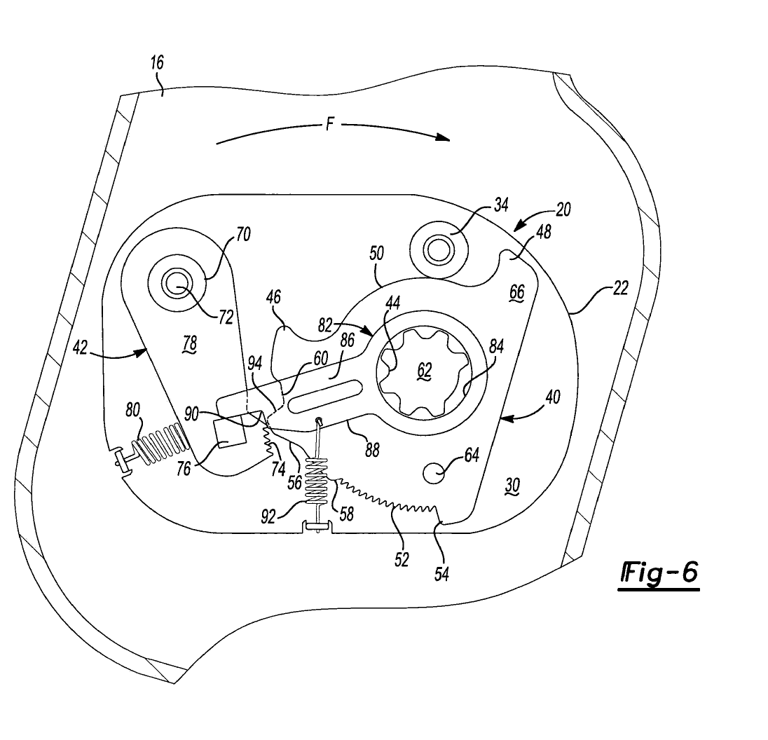

Rather than return the armrest assembly 16 to the use position, the armrest assembly 16 may be positioned in the stowed position once the teeth 74 of the pawl 42 are positioned opposite from the arcuate surface 58 of the sector plate 40. The armrest assembly 16 may be positioned into the stowed position by continuing rotation of the armrest assembly 16 in the counterclockwise direction relative to the view shown in FIG. 6. Continuing rotation of the armrest assembly 16 in the counterclockwise direction relative to the view shown in FIG. 6 causes the pawl 42 to engage the projection 56 of the sector plate 40 and ride along the projection 56 until the distal end of the pawl 42 is received within the detent 60. Once the pawl 42 is received within the detent 60 (FIG. 7), the armrest assembly 16 is in the stowed position and further rotation of the sector plate 40 is prevented due to engagement between the stow stop 48 and the post 34 as well as engagement between the pawl 42 and the detent 60.

To return the armrest assembly 16 to the use position, a force F is applied to the armrest assembly 16 to rotate the armrest assembly 16 and, thus, the sector plate 40, in the clockwise direction relative to the view shown in FIG. 6. The force F applied to the armrest assembly 16 must be sufficient to allow the distal end of the pawl 42 to disengage the detent 60 and allow the pawl 42 to ride along the projection 56 of the sector plate 40. The projection 56 may include a sloped surface 94 that opposes the detent 60 such that the pawl 42 rides along the sloped surface 94 when force F is applied to the armrest assembly 16 to move the armrest assembly 16 from the stowed position into the use position. The angle of the sloped surface 94 may be adjusted to tailor the force F required to release the distal end of the pawl 42 from the detent 60 and permit rotation of the armrest assembly 16 relative to the housing 22 from the stowed position into the use position.

Upon sufficient rotation of the armrest assembly 16 in the clockwise direction relative to the view shown in FIG. 6, the pawl 42 disengages the projection 56 such that the teeth 74 of the pawl 42 are spaced apart from and oppose the arcuate surface 58 of the sector plate 40 (FIG. 5). As discussed previously, the biasing member 80 is prevented from rotating the pawl 42 about the pivot 72 in the counterclockwise direction relative to the view shown in FIG. 6 due to engagement between the post 76 of the pawl 42 and the recess 90 of the reset lever 82. Maintaining a spaced relationship between the teeth 52, 74 prevents the teeth 52 of the sector plate 40 from engaging the teeth 74 of the pawl 42 and allows the sector plate 40 and, thus, the armrest assembly 16 to be rotated in the clockwise direction relative to the teeth 74 of the pawl 42 and into the use position (FIG. 2).

Once the armrest assembly 16 and the sector plate 40 have been sufficiently rotated in a clockwise direction relative to the view shown in FIG. 5, the post 64 of the sector plate 40 contacts the engagement surface 88 of the reset lever 82 and prevents further rotation of the reset lever 82 in the counterclockwise direction relative to the view shown in FIG. 2 by the biasing member 92. Preventing further rotation of the reset lever 82 in the counterclockwise direction relative to the view shown in FIG. 2 causes the post 76 of the pawl 42 to disengage the recess 90 of the reset lever 82. Disengagement of the post 76 from the recess 90 once again allows the biasing member 80 to apply a force on the pawl 42 and cause the pawl 42 to rotate in the counterclockwise direction relative to the view shown in FIG. 2.

Rotation of the pawl 42 in the counterclockwise direction relative to the view shown in FIG. 2 causes the teeth 74 of the pawl 42 to engage the teeth 52 of the sector plate 40 generally adjacent to the shoulder 54 of the sector plate 40. Engagement between the teeth 74 of the pawl 42 and the teeth 52 of the sector plate 40 prevents further rotation of the sector plate 40 and, thus, the armrest assembly 16, in the clockwise direction. In addition to engagement between the teeth 74 of the pawl 42 and the teeth 52 of the sector plate 40, the post 34 of the housing 22 engages the horizontal stop 46 of the sector plate 40 to further prevent rotation of the sector plate 40 and the armrest assembly 16 in the clockwise direction relative to the view shown in FIG. 2.

In this position, the armrest assembly 16 may once again be rotated in the counterclockwise direction relative to the view shown in FIG. 2 by applying force F to the armrest assembly 16 and causing the sector plate 40 to once again ratchet along the teeth 74 of the pawl 42. As noted above, such ratcheting allows the armrest assembly 16 to be positioned in any of the plurality of positions relative to the housing 22 with each angular position being achieved by releasing the force F applied to the armrest assembly 16 once a desired angle of the armrest assembly 16 is achieved.

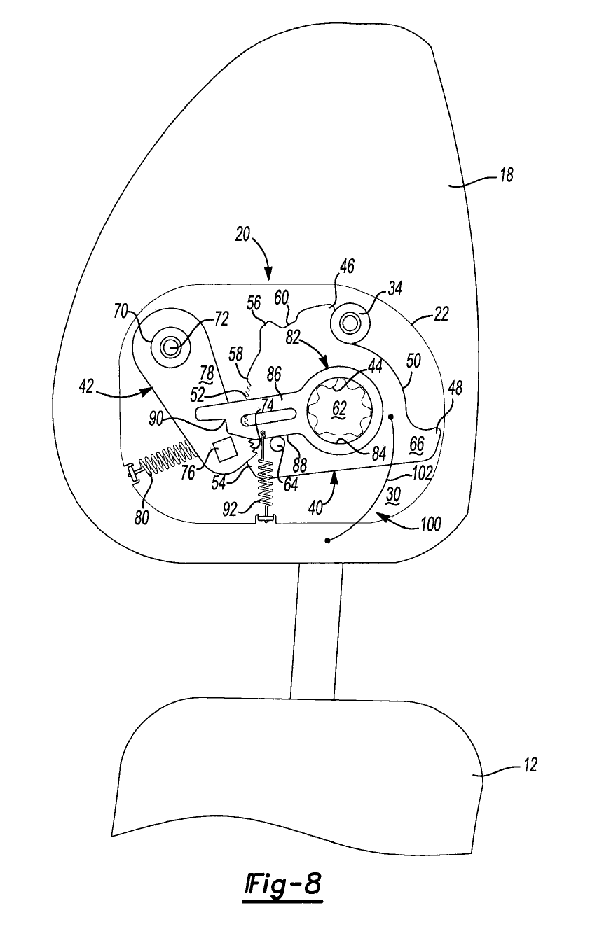

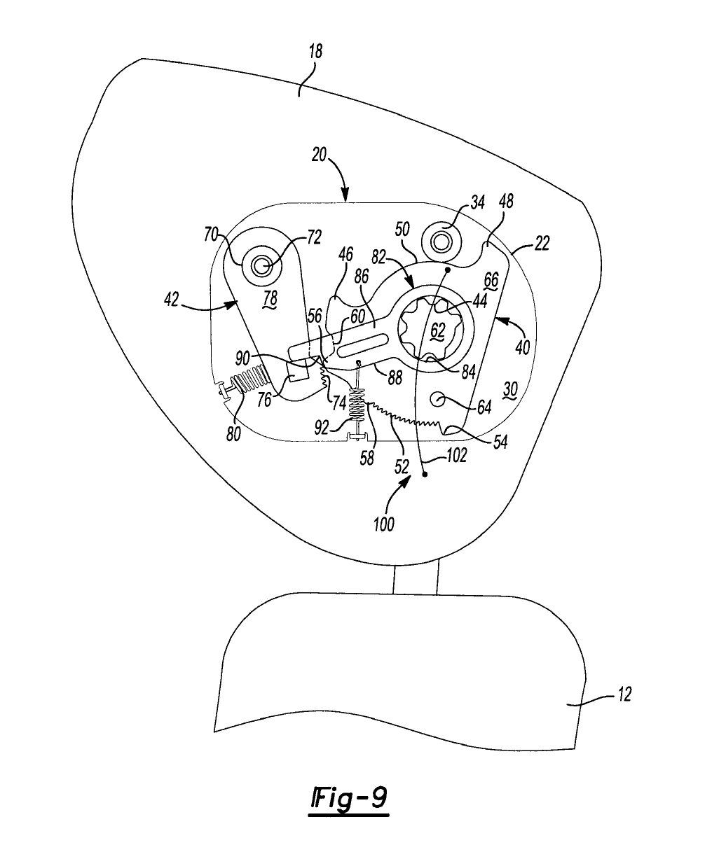

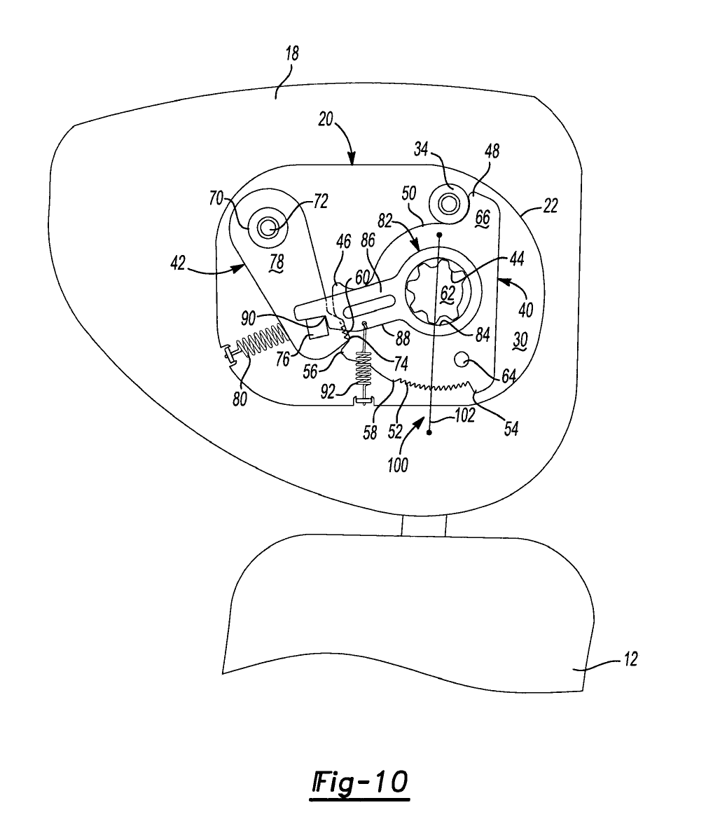

With reference to FIGS. 8-10, the adjustment mechanism 20 is shown incorporated into a headrest assembly 18. The adjustment mechanism 20 allows for angular adjustment of the headrest assembly 18 relative to the seatback 12 in a similar manner as described above with respect to the armrest assembly 16. FIG. 8 depicts the headrest assembly 18 in the use position, FIG. 9 depicts the angled use position, and FIG. 10 depicts the stowed position. Because operation of the headrest assembly 18 is substantially identical to that of the armrest assembly 16, a detailed description of the headrest assembly 18 is foregone.

The adjustment mechanism 20 may also be actuated into the stowed position by a remote actuation mechanism 100. For example in FIG. 8, the remote actuation mechanism 100 may include a cable 102 that is in communication with one of the sector plate 40 and the pawl 42 to automatically cause rotation of the sector plate 40 or the pawl 42 in response to rotation of the seatback 12 relative to the seat bottom 14.

The cable 102 may be fixedly attached at a first end to the vehicle floor 36, for example, and fixedly attached to the sector plate 40 at a second end such that rotation of the seatback 12 relative to the seat bottom 14 causes the cable 102 to be placed under tension. Placing the cable 102 under tension causes the sector plate 40 to rotate in a counterclockwise direction relative to the view shown in FIG. 8 and causes the sector plate 40 to ratchet along the teeth 74 of the pawl 42, in a similar fashion described above. This type of actuation mechanism 100 may be used to allow the headrest assembly 18 to automatically be positioned into the stowed position if the seatback 12 is rotated a predetermined amount relative to the seat bottom 14, thus, allowing the headrest assembly 18 to be stowed prior to positioning the seatback 12 in a dumped position relative to the seat bottom 14. Such positioning of the headrest assembly 18 prior to dumping of the seatback 12 relative to the seat bottom 14 is useful to allow for ease of operation of the seat assembly 10 into a dumped position.

What is claimed is:

1. An adjustment mechanism comprising:
a housing;
a pawl rotatably supported by said housing;
a sector plate rotatably supported by said housing and ratcheting along said pawl in a first rotational direction and operable to selectively lock said sector plate in one of a plurality of angular positions and to prevent rotation of said sector plate in a second rotational direction relative to said housing; and
a reset lever in selective engagement with said pawl to rotate said pawl out of engagement with said sector plate to permit rotation of said sector plate in said second rotational direction.

2. The adjustment mechanism of claim 1, wherein said pawl includes a first plurality of teeth and said sector plate includes a second plurality of teeth, said first plurality of teeth ratcheting along said second plurality of teeth when said sector plate is rotated in said first rotational direction.

3. The adjustment mechanism of claim 2, wherein said sector plate includes an arcuate surface disposed adjacent to said first plurality of teeth.

4. The adjustment mechanism of claim 3, wherein said arcuate surface extends from said sector plate farther than said first plurality of teeth.

5. The adjustment mechanism of claim 4, wherein said pawl is in selective engagement with said arcuate surface to rotate said pawl into engagement with said reset lever.

6. The adjustment mechanism of claim 5, wherein said engagement between said pawl and said reset lever causes said first plurality of teeth to be spaced apart from said second plurality of teeth to permit rotation of said sector plate in said second rotational direction.

7. The adjustment mechanism of claim 1, wherein said sector plate includes a detent that receives a distal end of said pawl to selectively prevent rotation of said sector plate relative to said housing.

8. The adjustment mechanism of claim 7, wherein said detent includes a tapered surface that engages said distal end of said pawl to allow removal of said pawl from said detent.

9. The adjustment mechanism of claim 1, further comprising a first biasing element biasing said pawl into engagement with said sector plate.

10. The adjustment mechanism of claim 1, further comprising a second biasing element biasing said reset lever into engagement with said pawl.

11. The adjustment mechanism of claim 1, wherein said sector plate includes a post extending therefrom for selective engagement with said reset lever to selectively prevent rotation of said reset lever and permit engagement between said pawl and said sector plate when said sector plate is rotated a predetermined distance in said second rotational direction.

12. An adjustment mechanism comprising:
a housing;
a sector plate rotatably supported by said housing; and
a pawl rotatably supported by said housing and in selective engagement with said sector plate to position said sector plate in one of a use position, an intermediate position, and a stowed position;
wherein said sector plate is rotatable from said intermediate position in a first direction into said stowed position and is rotatable in a second direction from said intermediate position into said use position.

13. The adjustment mechanism of claim 12, wherein said sector plate is in ratcheting engagement with said pawl in said use position.

14. The adjustment mechanism of claim 12, wherein said sector plate is in slidable engagement with said pawl in said intermediate position.

15. The adjustment mechanism of claim 12, wherein said pawl is received within a detent of said sector plate when said sector plate is in said stowed position.

16. The adjustment mechanism of claim 15, wherein said sector plate is moved into said intermediate position when rotated a predetermined distance in said first direction.

17. The adjustment mechanism of claim 12, further comprising a reset lever rotatable relative to said sector plate and operable to separate said pawl from said sector plate to permit rotation of said sector plate relative to said housing in said second direction.

18. A seat assembly comprising:
a seat bottom;
a seatback rotatably supported by said seat bottom;
at least one of an armrest assembly and a headrest assembly movable relative to said seatback; and
an adjustment mechanism associated with said at least one said armrest assembly and said headrest assembly, said adjustment mechanism comprising:
a housing fixed for rotation with one of said seat bottom and said seatback;
a sector plate rotatably supported by said housing and rotatable with at least a portion of said at least one said armrest assembly and said headrest assembly; and
a pawl rotatably supported by said housing and in selective engagement with said sector plate to position said sector plate in one of a use position, an intermediate position, and a stowed position relative to said seatback;
wherein said sector plate is rotatable from said intermediate position in a first direction into said stowed position and is rotatable in a second direction from said intermediate position into said use position.

19. The seat assembly of claim 18, wherein said sector plate is in ratcheting engagement with said pawl in said use position.

20. The seat assembly of claim 18, wherein said sector plate is in slidable engagement with said pawl in said intermediate position.

21. The seat assembly of claim 18, wherein said pawl is received within a detent of said sector plate when said sector plate is in said stowed position.

22. The seat assembly of claim 21, wherein said sector plate is moved into said intermediate position when rotated a predetermined distance in said first direction.

23. The seat assembly of claim 18, further comprising a reset lever rotatable relative to said sector plate and operable to separate said pawl from said sector plate to permit rotation of said sector plate relative to said housing in said second direction.
